(19) United States
(12) Patent Application Publication
(10) Pub. No.: US 2026/0264090 A1
(43) Pub. Date: Sep. 10, 2026

(54) ORGANIC WASTE PROCESSING DEVICE INSTALLABLE UNDER A KITCHEN SINK

(71) Applicant: STEEL PLAST d.o.o., Podnart (SI)

(72) Inventors: Valentin POGACNIK, Bled (SI); Valentin POGACNIK ML, Bled (SI)

(73) Assignee: STEEL PLAST d.o.o., Podnart (SI)

(21) Appl. No.: 19/469,721

(22) PCT Filed: Aug. 11, 2023
(86) PCT No.: PCT/IB2023/058123

§ 371 Date: Sep. 26, 2025

(30) Foreign Application Priority Data
Mar. 30, 2023 (SI) P-202300039

(51) Int. Cl. B02C 18/00; B02C 18/22; B02C 18/36

(52) U.S. Cl. CPC B02C 18/0092; B02C 18/2258; B02C 18/365; B02C 2201/063

(57) ABSTRACT

An organic waste processing device comprising a flange hub with an actuation plug, an inlet shaft, a conveying tube with a screw spindle, a dryer, a waste liquid collector, wherein the inlet shaft and the conveying tube are in fluid connection in a way to form an acute angle and the bottom opening of the inlet shaft coincides with the opening of the conveying tube so that together they form a coupling clearance with a coupling edge. The organic waste processing device has the waste liquid collector with an opening, the lowest point of which lies in a horizontal plane, in or above which the highest point of the coupling edge of the coupling clearance lies. The organic waste processing device has a flat conveying tube whose lowest point of the upper end is arranged above the horizontal plane in which the highest point of the coupling edge of the coupling clearance is located and above the lowest point of the opening of the waste liquid collector.

### SUBJECT OF INVENTION

The subject of the invention is an organic waste processing device, in particular for processing household organic waste, installable under a kitchen sink.

### TECHNICAL PROBLEM

The technical problem is to configure a device for processing organic waste produced in the kitchen during food preparation, which will process the organic waste to a dry organic matter stage, avoiding the emission of odours into the room, while also allowing the separation of oil and sediment from the waste liquid before it is discharged down the drain. The organic waste processing device must be dimensioned in such a way that, when installed under a kitchen sink, there will be sufficient space in the same undercounter cabinet to accommodate bins for other types of waste. At the same time, the device must meet all ecological and safety standards.

### PRIOR ART

As waste volumes increase, there is a tendency to recycle as much as possible, this is why waste is sorted. One type of waste that is not negligible in quantity and is also harmful to the environment is organic waste, especially from food preparation. It is collected in individual households, either in containers or bags, and taken to special dedicated bins and/or home composters, or even to residual waste bins. The contents of the containers are transported to a designated landfill for processing into compost or biogas. Organic waste collection in containers is particularly problematic in summer, when high temperatures accelerate the decomposition of organic waste, which is accompanied by bacterial growth, unpleasant odours and large amounts of methane gas. Another problem is the inadequate packaging in which direct users store and dispose of their household organic waste. Much organic waste is still disposed of inappropriately, i.e. in residual waste that needs to be microbiologically stabilised, or even in the toilet bowl, which is particularly burdensome for the sewage infrastructure and the environment.

To ensure that organic waste is stored and disposed of as cleanly and safely as possible, a number of devices have been configured. The simplest device is the so-called waste mill, which is placed in the drain pipe area of a kitchen sink below its outlet. Household organic waste is discharged through the kitchen sink drain into the mill, where it is ground and washed down the drain with a larger volume of water. A disadvantage of this way of disposing of organic waste is the high amount of nutrients in the sewer pipes, which contributes to an increased number of rodents in the sewers, creating an additional problem, as well as the high consumption of running water. For this reason, in many countries, this method of disposing of organic waste in households is not permitted.

A standalone device is known, the so-called household composter, which is placed near the kitchen sink. A device of this type has several chambers, usually two chambers, provided with a mixer and a heating element. Hot air drying is carried out at the same time as mixing. During mixing, the already dried and crushed organic waste is extracted through the sieved bottom of the chamber. After processing, the dry organic waste is removed from the device. During the process, which usually takes 6-12 hours, the device must be closed and no new organic waste can be added. During drying, warm air escapes into the room, causing unpleasant odours to develop in the room despite the use of filters. As the liquid is discharged by evaporation, these devices are not suitable for liquid organic waste. In addition, these devices are usually arranged on the countertop and take up a lot of space.

JP 2005152798 A (Tajima Tomohiro) describes an organic waste processing device installed under a kitchen sink and connected to it via a drainage pot. The organic waste collected in the drainage pot falls into a screw press which transports the waste towards the top end of the screw press, where the force of the screw pushes the waste through the screw press openings into the passageway and onwards towards the centrifugal unit. While being conveyed, the organic waste is drained off, with the drained liquid being discharged through slots at the bottom end of the screw press into the drained liquid collector and on to the drain. The crushed organic waste still contains too much liquid, so a centrifuge is used to remove this excess amount of liquid. The dewatered organic waste is conveyed to the waste collector by centrifugal force and a suction fan. The suction fan sucks in the odour of the decomposed organic waste along with the dry organic waste, which is then fed into the waste liquid drain to prevent the odour from spreading into the room. The device treats the organic waste on an as-needed basis once the drainage pot is full. When the device is not active, residual organic waste collects on the walls of the device's conveying passages. The waste immediately gets decomposed and an unpleasant odour is created. The organic waste residues are removed from the walls with the help of liquid-water that penetrates the drainage pot during standard kitchen sink use and flushes parts of the conveying passages. The liquid from the drainage pot flows through a side conveying passage to the centrifugal unit and on to the collector. Some of this liquid also percolates through the screw press openings into the press and partially removes the residual organic waste from the press wall. Only part of the residual organic waste can be removed in this way, and flushing must be carried out with a larger volume of water immediately after the device is shut down. Certain parts of the device, such as the conveying passage under the drainage pot and the screw of the screw press get insufficient flushing or no flushing at all. As a consequence, the residual organic waste decomposes within the device, developing unpleasant odour that spreads into the room, because the device and its individual parts are not airtight and do not include anti-odour filters. A further disadvantage is the size of the device, which takes up essentially all the space under the kitchen sink.

So there is a need for an organic waste processing device that will address the shortcomings described above.

### SOLUTION TO THE TECHNICAL PROBLEM

The relative terms such as lower, upper, front, rear, are defined depending on the orientation of the device in the working position.

The technical problem is solved by an organic waste processing device, in particular a household organic waste processing device, the main characteristics of which are defined in the independent claim 1.

An organic waste processing device, preferably a household organic waste processing device, comprises a positioning flange hub with an actuation plug for placing and positioning in the opening of a kitchen sink; an inlet shaft having a central axis extending vertically downwards from the positioning flange hub; a conveying tube having a central axis with a screw spindle; a dryer with a heating element and a dry organic matter collector; a waste liquid collector; drive elements; a conveying system for waste matter discharge; wherein the inlet shaft and the conveying tube form a fluid connection such that the central axis of the inlet shaft and the central axis of the conveying tube form an acute angle α and the bottom opening of the inlet shaft coincides with the opening of the conveying tube so that together they form a coupling clearance with a coupling edge. The device has a waste liquid collector provided with an opening, the lowest point of which is disposed in or above the horizontal plane in which the highest point of the coupling edge of the coupling clearance is disposed; a flat conveying tube connecting the conveying tube and the dryer, the lowest point of the upper end of the flat conveying tube being disposed above the horizontal plane in which the highest point of the lower edge of the coupling clearance is disposed and above the lowest point of the opening of the waste liquid collector. The inlet shaft and the conveying tube are arranged at an angle of less than 90° to each other. When both elements are filled with water, a siphon-style water barrier is formed, preventing odours from escaping from the device. The liquid level of the siphon is defined by the position of the opening in the waste liquid collector. In order to achieve a water barrier, the lowest point of the opening in the wall of the collector must be arranged higher than the highest point of contact between the opening of the inlet shaft and the opening of the conveying tube. At the same time, the liquid contained in the conveying tube is prevented from overflowing the flat conveying tube into the dryer. This is achieved by arranging the flat conveying tube so that its lowest point is higher than the lowest point of the waste liquid collector opening.

The cross-section of the flat conveying tube changes from a circular cross-section at the bottom end, which is in connection with the conveying tube, to a cross-section in the form of a flattened circle at the upper end, which is in connection with the dryer. The height distance between the lowest point of the upper end and the highest point of the coupling edge of the coupling clearance is >0 cm, preferably 0.5-5.0 cm, more preferably 1.0-3.0 cm, even more preferably 1.5-2 cm. Changing the cross-section from circular to flattened results in a lower height of the structure, while the cross-sectional area remains unchanged and thus does not affect the organic waste transport. The lowered structure makes the overall height of the device so small that, when installed under the kitchen sink, the device takes up only a portion of the space in the furniture cube. In this way, waste bins can be placed in the same furniture cube.

The screw spindle which is arranged in the conveying tube, has a knife arranged at the upper end with at least one substantially radial blade which rotates with it. The knife shreds the organic waste, which moves upwards due to the rotation of the screw spindle. As the shredded organic waste passes through the holes in the plate that encloses the conveying tube at the top end, it is further crushed and formed into reduced clumps, which dry more quickly.

The transport tube is formed on the bottom portion of its shell as a pre-stressed mesh strainer having openings of dimensions smaller than the dimensions of the through-holes of the plate which closes the upper opening of the conveying tube. This prevents the leakage of smaller organic waste into waste water. The relatively large surface area of the mesh strainer allows the waste liquid to drain smoothly from the conveying tube. While in operation, the screw spindle slides over the pre-stressed mesh strainer to remove any residual organic waste on the mesh strainer, thereby cleaning it.

The device is further provided with a dryer comprising a container, a rotary axis with blades and a heating element. The dryer further removes liquids from the organic waste from which most of the liquid has already been squeezed out, in order to achieve a reduction in the organic waste to up to 20% of the original amount. In addition, the organic waste is heated to a temperature of pasteurisation, which destroys micro-organisms and thus further waste decomposition.

The device comprises a waste liquid collector provided with a first chamber into which the waste liquid flows via a drain pipe and a second chamber into which the liquid from the first chamber flows, free of any sediment and oil. The household organic waste, as well as the liquids poured down the kitchen sink, often contain oils that are highly undesirable in municipal wastewater because of their negative impact on the functioning of wastewater treatment plants. The collector in the device is of such a size, both in volume and surface area, as to allow any particles in the waste water to settle and the oil to be brought to the surface in the first chamber. The wall of the second chamber has an opening that is offset in height from the bottom of the waste liquid collector and from the top edge of the wall of the second chamber. This achieves a flow of waste liquid free of organic particles and oil from the first to the second chamber and on to the municipal drain.

The device is switched on/off by a magnet/magnetic switch pair, with the magnetic switch arranged on the outside of the inlet shaft and the magnet arranged on the plug.

The magnetic switch detects the movement of the plug and switches the device on or off depending on the movement. If the user lifts or moves the plug during operation, the magnetic switch switches the device off. This prevents reaching into the device while it is in operation. This method of operation is user friendly, as the device is switched on by lifting the actuation plug to a position that allows the organic waste to be fed into the inlet shaft. An additional and important advantage of the described device operation is user safety. The device automatically switches off or does not switch on at all in the event of an incorrect plug position that would otherwise allow the user to reach into the device by hand or an object.

The organic waste processing device of the invention will be described in more detail below by way of an embodiment and drawings representing in

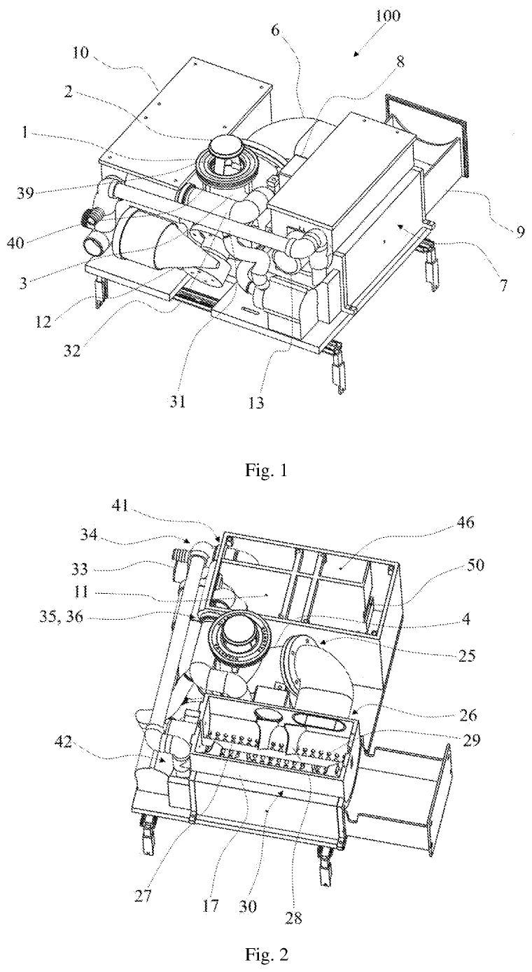

FIG. 1 an organic waste processing device in projection

FIG. 2 an organic waste processing device without covers, in projection

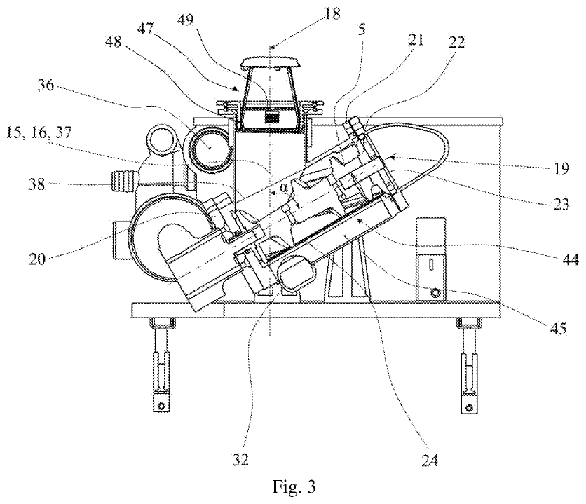

FIG. 3 an inlet shaft with a conveying tube and a screw spindle, in cross-section

An organic waste processing device 100, in particular for processing household organic waste of the invention comprises
a positioning flange hub 1 with an actuation plug 2 for installation and positioning in a kitchen sink opening,
an inlet shaft 3 extending vertically downwards from the positioning flange hub 1 to the conveying tube 4,
a conveying tube 4 with a screw spindle 5 in fluid communication with the inlet shaft 3,
a flat conveying tube 6 for the transport of the drained and shredded organic waste,
a dryer 7 with a heating element 8 and a dry organic matter collector 9,
a waste liquid collector 10 with a chamber 11,
drive elements 12, 13,
a conveyor system for waste matter discharge.

The organic waste processing device 100 is installed under a kitchen sink (not subject of the invention), with the positioning flange hub 1 inserted into the outlet opening of the kitchen sink and connected by an external thread 40 to the vertical inlet shaft 3 having an internal thread 39. The inlet shaft 3 is connected to the conveying tube 4 in such a way that a centre axis 18 of the inlet shaft and a centre axis 19 of the conveying tube form an acute angle α, where α is 10°-60°, preferably 20°-50°, more preferably 25°-45°. A bottom opening 15 of the inlet shaft coincides with an opening 16 of the conveying tube, so that the two openings together form a coupling clearance 37 with a coupling edge 38. A fluid connection is established which allows the conveying tube 4 to be filled with the organic waste pushed by the user through the positioning flange hub 1 into the vertical inlet shaft 3, as well as with the liquid which flows out of the kitchen sink during its normal use.

The conveying tube 4 is closed by a cover 20 at the end proximal to the inlet shaft 3. The screw spindle 5 arranged in the conveying tube 4 is centrally mounted in the cover 20 and driven by an electric motor 12 arranged on the outer side of the cover 20. The screw spindle 5 has a knife 22 arranged at its other, upper end with at least one substantially radial blade, preferably two radial blades, more preferably four radial blades, which rotate together with the screw spindle 5 and shred the organic waste. The organic waste is compressed by the action of the screw spindle 5 and displaced along the conveying tube 4 towards the knife 22 and further towards a plate 21 with through-holes 23, which closes the conveying tube 4 at the upper end. The organic waste pushed towards the top by the screw spindle 5 is reduced in size by being shredded and pushed through the holes 23 of the plate. At the same time, most of the liquid is removed from the organic waste and drained into a collector 45 through a bottom portion 44 of the conveying tube shell, which is formed as a pre-stressed mesh strainer 24. The mesh strainer 24 has openings with dimensions smaller than those of the kitchen sink mesh strainer openings and the through holes 23 of the plate, thus preventing the unprocessed organic waste or waste of larger dimensions from escaping into the drain. During operation, the screw spindle 5 slides over the mesh strainer 24, which is built in a pre-stressed manner, to clean it. The liquid collector 45 is positioned under the mesh strainer 24 and is either watertight to the conveying tube 4 or is in material-locking connection with the conveying tube. The liquid from the collector 45 is then discharged by means of a pump 42 through a waste liquid outlet pipe 32 into the waste liquid collector 10. When the device 100 is not in operation, the liquid from the kitchen sink K also drains through the mesh strainer 24 in the conveying tube 4 into the collector 45. Liquid drainage from conveying tube 4 will be described in more detail below.

The compressed and shredded organic waste is conveyed from the conveying tube 4 through the plate 21 and onwards along the flat conveying tube 6 to the dryer 7 by the action of the screw spindle 5. The cross-section of the flat conveying tube 6 changes from a circular cross-section at the bottom end 25, which is in connection with the conveying tube 4, to a cross-section in the form of a flattened circle at the upper end 26, which is in connection with the dryer 7. The flattened cross-section at the upper end 26 of the flat conveying tube 6 reduces the overall height of the device 100.

The dryer 7 comprises a container 17 in which a rotary axis 27 with blades 28 is arranged for intensive mixing of the organic waste. The axis 27 is driven by an electric motor 13 and preferably mounted in the side walls of the container 17. The dryer 7 further comprises a heating element 8 to blow hot air into the interior of the container 17 to remove any remaining liquid from the organic waste. The organic waste is heated to a temperature of at least 70° C. to kill bacteria, while at the same time the organic waste is heated to a temperature no more than 80° C. to preserve minerals. In the dryer 7, the organic waste is further crushed by mechanical agitation and drying.

Compression, shredding and crushing reduce the volume of the organic waste to 10-20% of the initial volume and weight, depending on the type of organic waste. The crushed dry organic waste falls through openings 29 arranged in a bottom 30 of the container into the dry organic matter collector 9. If necessary, the dry organic waste is disposed of from the dry organic matter collector 9. It can be used as a high-quality all-purpose organic fertiliser or disposed of in a composter, where it will quickly decompose into compost. As it is odourless, it can be kept in a dry place for any length of time.

The hot air, which also contains the liquid removed from the organic waste, is led from the dryer 7 through a waste air outlet pipe 31 to a waste liquid outlet 33, which is part of the sewerage system. A non-return valve 34 is provided in the waste air outlet pipe 31 to prevent the odorous air from returning to the dryer 7 and thus to the device 100 or the room.

The liquid drained and/or discharged from the organic waste and the liquid discharged from the kitchen sink during its normal use flow from the conveying tube 4 through the mesh strainer 24 into the collector 45, the waste liquid outlet pipe 32 and further into the waste liquid collector 10. The waste liquid outlet pipe 32 with its other end 35 extends into an opening 36 in the wall of the waste liquid collector 10. The opening 36 is positioned in the wall of the waste liquid collector 10 such that the lowest point of the opening 36 is in or above the horizontal plane in which the highest point of the coupling edge 38 of the coupling clearance 37, formed jointly by the inlet shaft 3 and the conveying tube 4, is located. The flat conveying tube 6 is flattened at the upper end 26 so that the lowest point of the upper end 26 is above the horizontal plane in which the highest point of the lower edge 38 of the coupling clearance 37 is located and above the lowest point of the opening 36. This achieves the overflow of the liquid into the collector 10 and at the same time prevents the liquid from overflowing into the dryer 7. The height distance between the lowest point of the upper end 26 and the highest point of the edge 38 is >0 cm, preferably 0.5-5.0 cm, more preferably 1.0-3.0 cm. In the embodiment, the height distance between the lowest point of the upper end 26 and the highest point of the edge 38 is 1.5-2 cm.

Both the liquid previously squeezed out of the organic waste and the liquid from the kitchen sink during normal use of the sink K flow into the waste liquid collector 10. These liquids may also contain oils. The waste liquid collector 10 is configured with a first chamber 11 into which the waste liquid flows via a drain pipe 32, and a second chamber 46 into which the liquid from the first chamber 11 flows, from which both the oil and any particles of organic waste have been previously separated. The size of the first chamber 11, and hence of the waste liquid collector 10, both in surface area and in volume, is such as to allow the removal of any particles of organic waste and oil from the waste liquid before it flows through an opening 50 from the first chamber 11 into the second chamber 46. The opening 50 is offset in height from the bottom of the waste liquid collector 10 to allow additional removal of any solid particles from the waste liquid and is offset in height from the top edge of the wall of the second chamber 46 to allow removal of oil from the waste liquid. From the second chamber 46, the purified waste liquid flows through the outlet opening 41 into the sewer drain. The waste liquid collector 10 is cleaned, if necessary, through a dedicated cleaning opening 43.

The device 100 is installed under the kitchen sink by means of a positioning flange hub 1, with the outlet of the kitchen sink coinciding with the inlet shaft 3 of the device. After the device 100 has been installed and/or prior to its first use, water from the kitchen sink K is discharged into the device 100 to fill the inlet shaft 3, the conveying tube 4 to a height equal to the height of the lowest point of the opening 36 in the wall of the collector 10, and the waste liquid collector 10. When the device 100 is not in use, the liquid from the kitchen sink flows freely out of the sink through the discharge opening and through the device 100, which in its non-functional state acts as a drain with a siphon.

The device 100 is actuated by means of an actuation plug 2 arranged in the flange hub 1 by a magnet 48/magnetic switch 49 pair. At least one magnet 48, preferably a pair of magnets, is arranged on a guide section 47 of the actuation plug, the two magnets 48 being spaced 180° apart, and at least one magnetic switch 49, preferably three magnetic switches, are arranged on the outer side of a cylindrical body 5 of the positioning flange hub 1 at a spacing of 120° apart. When in the closed position, the actuation plug 2 is inserted its full length into the flange hub 1, sealing it completely and preventing the liquid from flowing out of the kitchen sink. Each magnet 48 and each magnetic switch 49 are spaced apart, there is no interaction and the device 100 is at a standstill. By displacing the actuation plug 2 to the open position, the flange hub 1 is opened to such an extent that only liquid is allowed to flow out of the kitchen sink. Each magnet 48 and each magnetic switch 49 are still spaced apart, there is no interaction and the device 100 is not activated. By lifting the actuation plug 2 to the actuation position, the opening between the flange hub 1 and the actuation plug 2 is such as to permit the insertion of organic waste into the inlet shaft 3 and, at the same time, is such as to prevent the user from reaching into the inlet shaft 3 with his hand. The magnet 48 is lifted together with the actuating plug 2, which is detected by the magnetic switch 49. The magnetic switch 49 turns on the pump 42, arranged in the waste liquid outlet pipe 32, and the screw spindle 5. The pump 42 starts pumping the liquid from the conveying tube 4 and the inlet shaft 3, the screw spindle 5 compresses and advances the organic waste coming down the inlet shaft 3. The liquid from the organic waste flows through the mesh strainer 24 into the collector 45, the waste liquid outlet pipe 32 and on to the collector 10. The organic waste, the liquid of which has been removed, is pushed by the screw spindle 5 towards the knife 22 which shreds it and onwards through the through-holes 23 of the plate 21 into the flat conveying tube 6. The organic waste is conveyed further towards the dryer 7 due to the continuous feeding of the waste into the flat conveying tube 6. In the collector 17, the organic waste is blown with hot air while mixed, wherein it gets dried and reduced in volume, and it can also be further crushed. The dry and appropriately sized organic waste that has been reduced in size to up to 20% of its original size is collected in the dry matter collector 9. The dry organic waste is removed from the dry matter collector 9 as required or when the collector 9 is full. The organic waste processed in this way is odourless. Heating to a temperature of pasteurization of at least 80° C. removes micro-organisms that would develop odour and/or damage the ecosystem.

The device 100 stops operating when the user moves the actuation plug 2 back to a position that only allows water to flow out of the kitchen sink, but does not allow organic waste to be fed in. After the device 100 has finished operating, the kitchen sink is used as a normal kitchen sink. The liquid flowing out of the kitchen sink fills the coupling clearance 37 as well as the inlet shaft 3 and the conveying tube 4 to a level that creates a water barrier between the flat conveying tube 6 and the inlet shaft 3. This prevents odour from escaping from the device, in particular from the flat conveying tube 6, which contains the residual organic waste that has not been conveyed to the dryer 7 after the device 100 has stopped operating.

The device 100 also stops operating if the actuation plug 2 is fully withdrawn from the flange hub 1. This prevents interference with the operating device. The magnet 48/magnet switch 49 pairs are provided on the actuation plug 2 and the flange hub 1 in such a way that, depending on the rotation of the actuation plug 2 to the left or right direction about its longitudinal axis, the screw spindle 5 rotates in one direction or the other. The rotation of the screw spindle 5 in different directions prevents the organic waste from getting stuck in the conveying tube 4.

1. An organic waste processing device, in particular for processing household organic waste, comprising
a positioning flange hub with a plug for installation and positioning in a kitchen sink opening,
an inlet shaft having a centre axis and extending vertically downwards from the positioning flange hub,
a conveying tube having a centre axis with a screw spindle,
a dryer,
a waste liquid collector,
drive elements,
a conveyor system for waste matter discharge,
characterized in that
the inlet shaft and the conveying tube form a fluid connection therebetween, wherein an acute angle is formed between the centre axis of the inlet shaft and the centre axis of the conveying tube and the bottom opening of the inlet shaft coincides with the opening of the conveying tube so that together they form a coupling clearance with a coupling edge, the highest point of which lies in or above the horizontal plane in which the lowest point of an inlet opening of the waste liquid collector lies, and the conveying tube is connected to a flat conveying tube connecting the conveying tube and the dryer, wherein the lowest point of the upper end of the flat conveying tube is arranged above the horizontal plane in which the highest point of the coupling edge of the coupling clearance is located and above the lowest point of the opening of the waste liquid collector.

2. The device according to claim 1, characterized in that the cross-section of the flat conveying tube changes from a circular cross-section at the bottom end of the flat conveying tube, which is in connection with the conveying tube, to a cross-section in the form of a flattened circle at the upper end of the flat conveying tube, which is in connection with the dryer.

3. The device according to claim 1, characterized in that the height distance between the lowest point of the upper end of the flat conveying tube and the highest point of the edge of the coupling clearance is >0 cm, preferably 0.5-5.0 cm, more preferably 1.0-3.0 cm.

4. The device according to claim 1, characterized in that the conveying tube is closed at its upper end by a plate provided with through-holes for crushing organic waste.

5. The device according to claim 1, characterized in that the screw spindle arranged on the conveying tube has a knife provided at its upper end with at least one substantially radial blade which rotates together with the screw spindle.

6. The device according to claim 1, characterized in that the conveying tube is formed on the bottom portion of its shell as a pre-stressed mesh strainer.

7. The device according to claim 6, characterized in that the mesh strainer has openings of dimensions smaller than the dimensions of the through-holes of the plate.

8. The device according to claim 1, characterized in that the dryer comprises a container in which a rotary axis with blades is arranged.

9. The device according to claim 1, characterized in that the waste liquid collector is configured with a first chamber into which the waste liquid flows via a drain pipe, and a second chamber into which the liquid from the first chamber flows.

10. The device according to claim 10, characterized in that the second chamber has an opening that is offset in height from the bottom of the waste liquid collector and offset in height from the top edge of the wall of the second chamber.

11. The device according to claim 1, characterized in that the actuation plug and the inlet shaft comprise at least one magnet magnetic switch pair.

12. The device according to claim 1, characterized in that the dryer comprises a heating element and a dry organic matter collector wherein the heating element heats the organic waste to a temperature of pasteurisation, preferably to 80° C.
